(19) United States
(12) Patent Application Publication
(10) Pub. No.: US 2017/0185287 A1
(43) Pub. Date: Jun. 29, 2017

(54) Adapting a virtual keyboard in the presence of static contact events

(71) Applicant: Nuance Communications, Inc., Burlington, MA (US)

(72) Inventors: Erland Unruh, Burlington, MA (US); David J. Kay, Burlington, MA (US)

(21) Appl. No.: 14/998,216

(22) Filed: Dec. 23, 2015

(51) Int. Cl. G06F 3/0488; G06F 3/041

(52) U.S. Cl. CPC G06F 3/04886; G06F 3/041

(57) ABSTRACT

System and methods are provided for adapting a virtual keyboard of a computing device in response to a detected static contact event. The system utilizes characteristics of a touch input to a touchscreen of the computing device, such as location of the touch input, surface area of the touch contact, and duration of the contact, to evaluate whether the touch input is likely an unintentional resting touch caused, for example, by a user resting his or her hand or finger on the touchscreen. If the touch is determined to be a static contact event, and if the event interferes with (e.g., overlaps or obstructs) portions of the virtual keyboard, the layout or behavior of the keyboard adapts to improve user functionality.

### BACKGROUND

With the emergence of smartphones, tablets, and hybrid devices (e.g., mini tablets) and with the integration of touch interface technology onto computers, users are capable of providing inputs to those computing devices through an additional input element: touchscreens. Touchscreen displays are now an industry standard on cellular telephones, tablets, laptops and even some desktop computers.

A touchscreen combines various traditional input elements, e.g., a traditional mouse and keyboard, into one by combining the functionality of each element into one device. In order provide this functionality, the touchscreen often displays a virtual keyboard to users when keyed entries are required. The displayed keyboard is generated either automatically by an application or at the user's request.

Because of the size of the devices on which they are incorporated, touchscreens typically occupy most of the user-facing device surface, leaving little non-touchscreen case or bezel on the front of the device. As a result, a user may inadvertently rest a part of a hand or finger on an edge of the touchscreen while holding the device. Additionally, in part due to lack of three-dimensional depth of keys of the virtual keyboard, a user using a portion of the keyboard may inadvertently rest a part of a hand or finger on a different portion of the keyboard. Because virtual keyboards often take up much of the touchscreen space and because keys are packed close together, there is a high likelihood that a resting hand or finger will obstruct a portion of the virtual keyboard.

Therefore, the need exists for a system that overcomes the above problems, as well as one that provides additional benefits. Overall, the examples herein of some prior or related systems and their associated limitations are intended to be illustrative and not exclusive. Other limitations of existing or prior art systems will become apparent to those of skill in the art upon reading the following Detailed Description.

### BRIEF DESCRIPTION OF THE DRAWINGS

FIG. 1 illustrates an example of a computing environment in which an adaptive virtual keyboard may be implemented.

FIG. 2 is a block diagram of example components in a mobile device or suitable computing device capable of providing a virtual keyboard on a touchscreen display.

FIG. 3A is a flow diagram depicting an example method for detecting static contact events on a touchscreen.

FIG. 3B is a flow diagram depicting an example method for adapting a virtual keyboard in response to detecting a static contact event.

FIG. 4A illustrates a time diagram of a threshold time for a duration of a contact event to qualify as a static contact event.

FIG. 4B illustrates a location diagram of a threshold distance for a location of a contact event to qualify as a static contact event.

FIG. 4C illustrates a perimeter of a virtual keyboard from which a location of a contact event is determined.

FIG. 5A illustrates contact events detected on a touchscreen and relative to a virtual keyboard displayed on that touchscreen.

FIG. 5B illustrates an adaptation of the virtual keyboard based on the contact events in FIG. 5A.

FIG. 5C illustrates another adaptation of the virtual keyboard based on the contact events in FIG. 5A.

FIG. 6A illustrates contact events detected on a touchscreen and relative to a virtual keyboard displayed on that touchscreen.

FIG. 6B illustrates an adaptation of the virtual keyboard based on the contact events in FIG. 6A.

FIG. 6C illustrates another adaptation of the virtual keyboard based on the static contact events in FIG. 6A.

FIG. 7A illustrates contact events detected on a touchscreen and relative to a virtual keyboard displayed on that touchscreen.

FIG. 7B illustrates an adaptation of the virtual keyboard based on the contact events in FIG. 7A.

### DETAILED DESCRIPTION

A system and method for adapting a virtual keyboard in response to unintentional touch inputs is described herein. The system assesses characteristics of a touch input to, for example, a touchscreen of a computing device to determine whether the touch input is an intentional or unintentional input. As used throughout this description, an “unintentional” input is a touch input for which no interaction with an underlying touchscreen element is intended, even if the touch itself is intentional. That is, an unintentional touch input may be caused by a user's unintended touch of a touchscreen. An unintentional touch input may also be the result of a user intentionally resting a hand on the touchscreen while anticipating adaptation by the virtual keyboard, and thus not intending an interaction with any virtual keyboard key. Unintentional touch inputs can be of brief or long duration, depending on the cause of the input. For example, a long unintentional touch input could be caused by a user's finger resting on the edge of the touchscreen while holding the computing device, or by a user resting a palm on a portion of the virtual keyboard while typing on another portion of the keyboard. A brief unintentional touch input could be caused by a momentary accidental touch or brush of the touchscreen. Upon detecting the unintentional touch input, the system dynamically adapts the virtual keyboard, for example how the keyboard is displayed on the touchscreen and how the keys are arranged, to compensate for obstruction or interference caused by the detected unintentional touch input. Adapting the virtual keyboard in response to an unintentional touch input can improve both the user experience and system performance.

By detecting unintentional touch events, the adaptive keyboard system enables a user to comfortably rest his or her hands or fingers on a virtual keyboard without affecting the detection of other touch inputs, or without being forced to uncomfortably avoid resting on the keyboard. Furthermore, the adaption of the keyboard in response to the unintentional touch events, which could comprise shifting all or a portion of the virtual keyboard or altering the arrangement or size of keys to avoid the unintentional touch, preserves full virtual keyboard functionality in spite of an obstruction or interference caused by the touch event. Additionally, detecting unintentional touch events has other benefits. Since the adaptive keyboard system detects unintentional touch inputs, those inputs can be ignored or otherwise not processed. Ignoring unintentional touch inputs allows the system to more effectively process concurrent and subsequent intentional touch inputs. As a result, new touch inputs are more rapidly identified as intentional key presses, thereby improving text entry detection by the system.

For purposes of the following description, a “contact event” is a detected user interaction (e.g., a touch) on a touchscreen of a computing device. The user interaction can be initiated by a user's finger, stylus, hand, pointing apparatus, or any other mechanism for providing an interaction that is detectable by the touchscreen. A “static contact event” is a contact event that exceeds a certain threshold in length, such as a long unintentional touch input caused by a resting finger on the keyboard.

Note that while the example of a virtual keyboard is used throughout this description to facilitate explanation, the techniques introduced here are also potentially applicable to other types of user input features displayed on a touchscreen device, such as pull-down menus, text entry fields, radio buttons, slider bars, check boxes, etc.

The described keyboard adaptation system utilizes data collected from multiple contact events to determine whether each of the multiple contact events is an unintentional touch input and, if so, the type of unintentional touch input. As described above, a brief unintentional user input may be caused by a momentary accidental touch of the touchscreen. A long unintentional user input may be caused by a user resting a hand or finger at a location on the touchscreen while not intending to interact with a key at that location, which is referred to as a static contact event.

As described in commonly-assigned U.S. patent application Ser. No. 14/450,095, filed on Aug. 1, 2014, entitled, “SYSTEM AND METHODS FOR DETERMINING KEYBOARD INPUT IN THE PRESENCE OF MULTIPLE CONTACT POINTS,” which is hereby incorporated by reference in its entirety, various factors may be used to assess whether a contact event represents an unintentional touch input. For example, a system for detecting unintentional touch inputs may consider the duration of a contact event, the location of the contact event relative to a reference location, and the surface area of the contact event. Even though each of the multiple contact events is considered to be a physically independent action, the assessment of one contact event may influence the assessment of another contact event occurring substantially concurrently with the first contact event. Additionally, the factors may depend on one another such that a factor (e.g., surface area) is only assessed in the event of a particular outcome (e.g., favorable or unfavorable) after assessing a different factor (e.g., location). Such a system may also differentiate between a brief unintentional touch input and a long unintentional touch input. A long unintentional touch input, or static contact event, may be defined as a sustained contact event exceeding a threshold time, and represents a resting touch that is not intended by the user as an input.

If the adaptive keyboard system detects a static contact event, the system determines whether that static contact event interferes with or obstructs. the displayed virtual keyboard. Interference can include preventing access to a portion of the useable displayed virtual keyboard, such as blocking or covering input keys of the virtual keyboard. To detect interference, the area of a static contact event, based on the location and surface area of the contact event, may be compared against an element of the keyboard, such as the perimeter or boundary of the virtual keyboard. If the adaptive keyboard system determines that the static contact event is within the boundary of the keyboard, or near enough to the boundary so as to obstruct keys of the keyboard, then the static contact event is interfering.

Accordingly, a first factor considered by the keyboard adaptation system when analyzing a static contact event can be the location of the contact event, and in particular a position and distance of the contact event relative to features of the displayed virtual keyboard. The location of a detected static(?) contact event can be instrumental in determining the type of contact event and whether the displayed keyboard should be adapted due to that contact event. The location can be measured relative to the displayed virtual keyboard in various ways. In some embodiments, the location is determined based on a distance from a predetermined starting point on the displayed virtual keyboard, such as a distance from a home key, edge, or corner of the keyboard. In other embodiments, the location is determined in relation to a particular edge or corner of the touchscreen of the computing device.

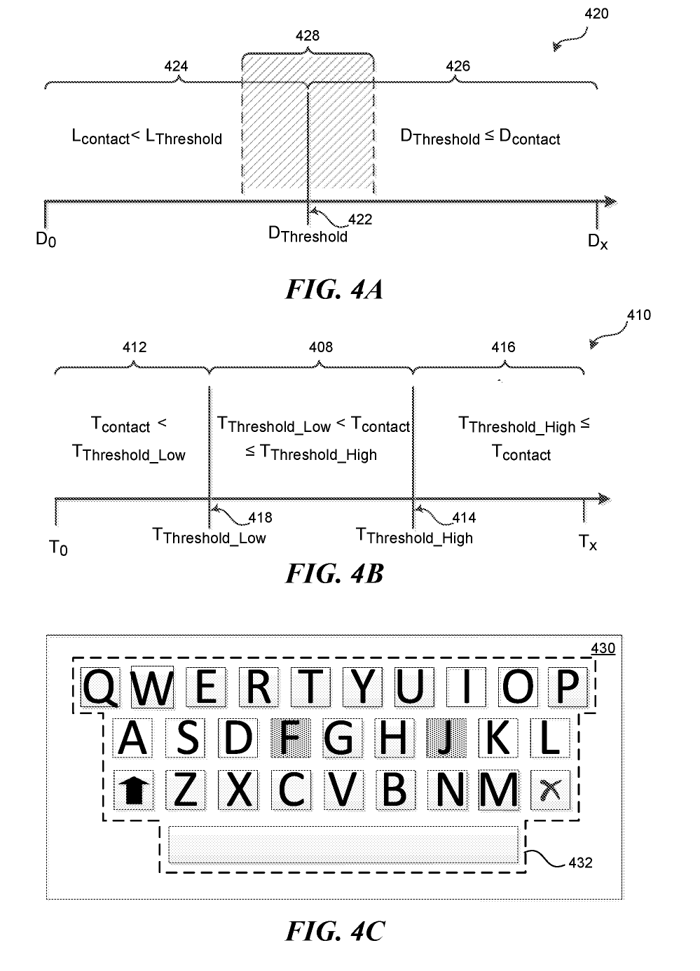

When considering the location of a contact event, the adaptive keyboard system may determine whether the contact event is on the virtual keyboard (inside the keyboard perimeter) or off the virtual keyboard (on or outside the perimeter). For purposes of the following discussion, the perimeter is defined along the outside edge of the outermost input keys on the virtual keyboard (e.g., perimeter 432 in FIG. 4C). For example, if a detected static contact event is detected centrally on the keyboard, e.g., near the home keys, then the manner of adaptation of the virtual keyboard may be different than if the static contact event is located on or near the virtual keyboard perimeter.

A second factor, the size and shape of a detected contact event, may also be utilized to assess whether a detected static contact event necessitates virtual keyboard adaptation, and if so, how the keyboard should be adapted. The size of the contact event may be measured by a surface area of the contacted portion of the touchscreen.

When a static contact event is determined to be interfering, based on the factors described above, the system evaluates the static contact event to select a type of adaptation to apply to the virtual keyboard. In an embodiment of the adaptive keyboard system, the multiple adaptation types involve a graphical alteration of the virtual keyboard such that the user is able to access the previously-interfered with portion of the keyboard in an unobstructed space. For example, the adaptive keyboard system may morph the layout of the virtual keyboard, such as by relocating the specific keys obstructed by the static contact event (e.g., shifting radially the keys underneath a resting hand or finger). The adaptive keyboard system may also resize keys of the virtual keyboard or alter the spacing between keys. The adaptive keyboard system may also morph the entire virtual keyboard, such as by shifting the entire virtual keyboard away from the location of the static contact event or uniformly re-sizing the virtual keyboard to avoid the static contact event. The type of adaptation selected by the adaptive keyboard system may depend on the location of the static contact event. For example, if the static contact event is located at the boundary of the keyboard, the entire keyboard may be shifted. If the static contact event is located within the boundary of the keyboard, the boundary of the keyboard may remain unchanged but the keys within the keyboard may shift, be resized, or be re-arranged.

The adaptive keyboard system, either after making an initial selection of a type of adaptation to apply or concurrently with the initial selection, evaluates the selected adaptation type to determine whether any rules would be violated by the adaptation. For example, the adaptive keyboard system may initially select shifting the virtual keyboard to avoid a static contact event near the keyboard boundary and then determine that the shift would require shifting a portion of the keyboard onto impermissible space (e.g., outside the viewing window of the touchscreen, or onto touchscreen area allocated to an application running on the device); the adaptive keyboard system would then select a different adaptation type, such as uniformly reducing the size of the virtual keyboard. In another example, the adaptive keyboard system may initially select uniformly reducing the size of the virtual keyboard, then determine that the adapted keyboard would be too small for user use (e.g., key size or spacing between keys would be below some minimum size or distance). In that case the adaptive keyboard system would select an alternative adaptation type, such as re-arranging or re-sizing individual keys. When evaluating selected adaption types, the adaptive keyboard system may consider any rules related to virtual keyboard usability or device limitations.

Instead of visually morphing the virtual keyboard (i.e., displaying to a user the keyboard modified by the selected adaptation), the adaptive keyboard system may only logically morph the virtual keyboard. When the adaptive keyboard system utilizes logical morphing, the system maps the keys of the virtual keyboard to new touchscreen locations according to the adaptation, and processes subsequent inputs accordingly. However, the display of the virtual keyboard is not modified (i.e., the keyboard is displayed as it was prior to the obstruction).

In addition to morphing the virtual keyboard, the adaptive keyboard system may provide feedback to a user to indicate the detection of an interfering static contact event. For example, the system may generate haptic feedback at the location of the static contact event to call the user's attention to the resting finger or hand.

Adaptation of the virtual keyboard may depend on the behavior of the key interfered with by the static contact event. For example, if the underlying key has a sensible repeat behavior, such as the delete key, then the static contact event may indicate a desire to repeatedly perform that action. In such case, the adaptive keyboard system may not morph the virtual keyboard around the static contact event, and may instead treat the static contact event as a conventional and intentional touch input.

In some embodiments, the adaptive keyboard system may track a shift of the user's hands and further adapts a previously adapted virtual keyboard to account for the shift. For example, the user's hands may naturally drift during use of the virtual keyboard. As a result, a static contact event may be detected a distance from the location where a first static contact event was detected. For example, when the system determines that a static contact event has moved, the keyboard can subsequently be shifted, space permitting, according to the updated position of the static contact event, thus correcting for the drift. If the space for adapting the keyboard is no longer available, the system can then determine an alternate adaptation method for the keyboard to prevent interference with the static contact event and to fit within the space available. For example, if the keyboard is shifted horizontally too far in one direction, the keyboard adaptation module can determine that a shift plus a slight skew would accommodate the contact event and available space.

The adaptive keyboard system may utilize different thresholds associated with the described factors for assessing whether a detected touch input is a static contact event, whether the static contact event interferes with the virtual keyboard, and how the virtual keyboard should be adapted to mitigate the interference. The thresholds used by the adaptive keyboard system may be dynamic and change over time, for example, with respect to a specific user, with respect to an application in which the keyboard is displayed (i.e., application integration), or with respect to an already adapted virtual keyboard. The threshold factors considered to determine a static contact event can vary substantially based on the detected contact event as well. Fixed thresholds may also be used.

In some embodiments, the device may store the location of the detected static contact event in case of a later reoccurrence. Typing by a specific user is usually a habitual action, so resting a palm, finger, or other portion of the hand at or proximate to the same location on the touchscreen while entering text often occurs each time the keyboard is displayed. Accordingly, after several uses, the computing device can collect data regarding the habitual entry methods by that user and then modify thresholds and/or other factors used to detect contact events in order to accommodate that user. Storing the location of commonly reoccurring static contact events can also allow for quicker detection of a static contact event. For example, the keyboard may be adapted initially to accommodate repeated static contact events. If those static contact events are not detected within an allotted time interval after display of the virtual keyboard or during initial keyed entries, the keyboard can be shifted back to its original, or home position.

The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention. Various implementations of the system will now be described with reference to the aforementioned embodiments, as well as, additional embodiments within the scope of the system.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be a requirement for some embodiments but not for other embodiments.

### I. Suitable Systems

The discussion herein provides a brief, general description of a suitable computing environment in which aspects of the present system can be implemented. Although not required, aspects of the system are described in the general context of computer-executable instructions, such as routines executed by a general-purpose computer, e.g., mobile device such as a smartphone, tablet, notebook or laptop computer, a server computer, or personal computer. Those skilled in the relevant art will appreciate that the system can be practiced with other communications, data processing, or computer system configurations, including: Internet appliances, hand-held devices (including personal digital assistants (PDAs)), all manner of cellular or mobile phones, wearable computers, embedded systems, vehicle-based computers, multi-processor systems, microprocessor-based or programmable consumer electronics, set-top boxes, network PCs, mini-computers, mainframe computers, and the like. Indeed, the terms “computer,” and “mobile device” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media, including magnetically or optically readable computer discs, hard-wired or preprogrammed chips (e.g., EEPROM or flash semiconductor chips), nanotechnology memory, biological memory, or other data storage media. Alternatively, computer implemented instructions, data structures, screen displays, and other data under aspects of the system may be distributed over the Internet or over other networks (including wireless networks). Those skilled in the relevant art will recognize that portions of the system may reside on a server computer, while corresponding portions reside on a client computer such as a mobile or portable device, and thus, while certain hardware platforms are described herein, aspects of the system are equally applicable to nodes on a network. Aspects of the invention will now be described with reference to the figures.

### II. Suitable Environment

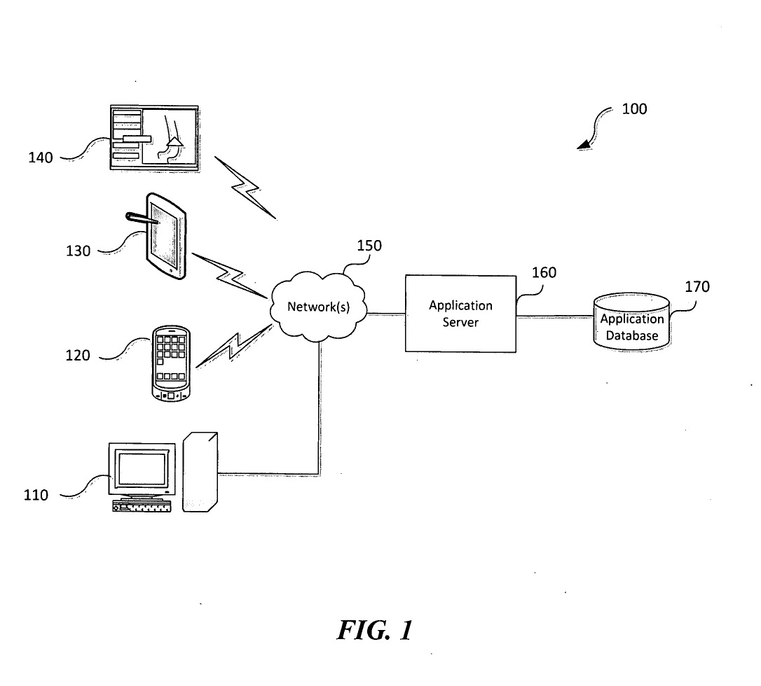

A suitable or representative environment 100 in which the adaptive keyboard system may be implemented is shown in FIG. 1. FIG. 1 shows one or more communication networks 150 coupled to various computing devices capable of storing and running applications and communicating on the networks 150. For example, the devices may include a desktop computer 110, a mobile phone 120, a tablet computer 130, a GPS navigation system 140, a laptop computer (not shown), and/or other computing devices. The devices 110, 120, 130, 140, can include various input mechanisms (e.g., microphones, keypads/keyboards, and/or touchscreens) to receive user inputs (e.g., voice, text, and/or handwriting inputs). In particular, devices with touchscreens include a virtual keyboard application stored on or accessible via the devices that allows users to enter text by typing or entering text on a virtual keyboard displayed on a touchscreen of the devices. In addition, the devices include an application stored on or accessible via the devices which interprets contact events on the virtual keyboard and adapts the displayed virtual keyboard in order to facilitate data entry into a device.

An application server 160 configured to provide virtual keyboard software and/or other application software and updates for that software to each of the devices is also illustrated. The virtual keyboard and/or other application software may be stored in an application database 170 stored in or in communication with the application server 160. The application server 160 may be coupled to the networks 150 via a wireless or hard-wired connection, such as an Ethernet connection, IEEE 802.11 connection, or other communication channel known in the art which is formed between the server and the network. Additional details of a mobile device, keyboard-related applications and corresponding methods are further described with reference to the remaining figures.

### III. Touchscreen Device

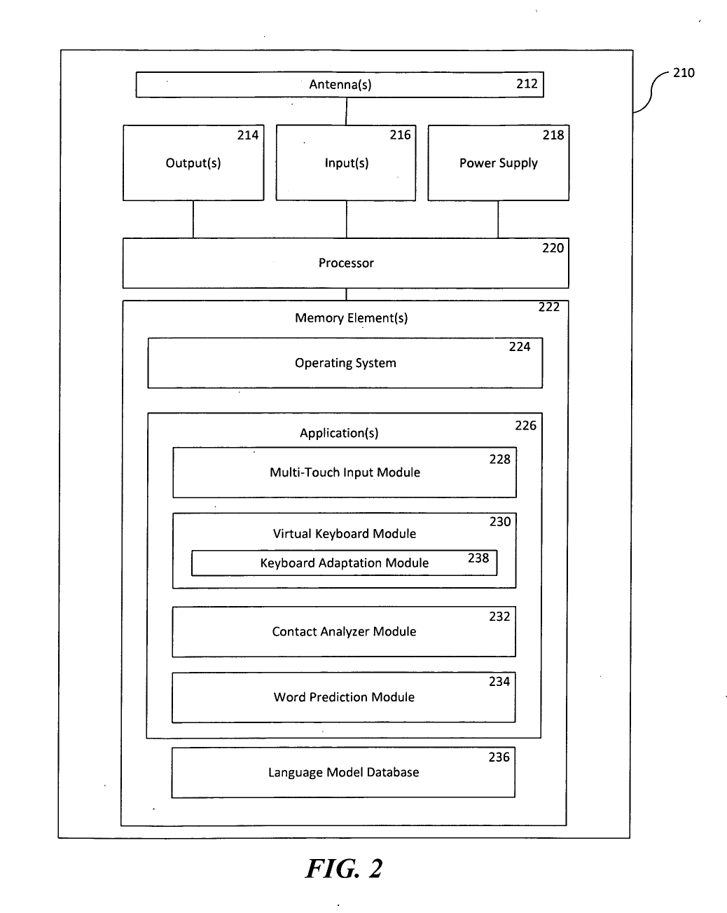

FIG. 2 illustrates an example mobile device 210. The mobile device 210 includes a touchscreen that is used to implement the methods for analyzing contact events and adapting a virtual keyboard on the touchscreen as provided in the following description. In particular, FIG. 2 illustrates components of a mobile device 210 on which a virtual keyboard is displayed for text entry by a user. The illustrated mobile device 210 is a computing device having a storage medium encoded with instructions capable of being executed by a processor to perform methods disclosed within those instructions. The mobile device 210 may be, for example, a smartphone, tablet computer, notebook computer, mobile GPS navigation device, e-reader, personal wireless device (e.g., mobile hotspot), or any other device that is capable of storing an application and generating a virtual keyboard on a touchscreen display of the mobile device 210. While not depicted in FIG. 2, many of the components in the mobile device 210 can also be present in other suitable computing devices that implement the disclosed technology. For example, a surface or tabletop computer, desktop computer, server computer, or fixed telephone or communications console or apparatus may all have the same or similar components to those depicted in the mobile device 210.

The mobile device 210 is configured to record and temporarily store contact events reflecting interaction with the touchscreen either on or adjacent to a displayed virtual keyboard. Each of the components within the mobile device 210 is connected to a system bus (not shown) that is capable of transferring data between those components. The mobile device 210 also has a power supply 218, such as a battery, which is capable of providing power to each of the components within the mobile device 210.

The mobile device 210 further includes one or more antennas 212 capable of communicating via radio networks with a cellular communications network (e.g., GSM, CDMA, 3G, 4G), a wireless local area network (e.g., WiFi), other devices using near field communication (NFC, RFID) or Bluetooth, and a satellite system (GPS). The antennas 212 may be coupled to a processor 220, which facilitates the sending and receiving of communication signals to/from the aforementioned networks.

Various input components 216 for receiving input signals and various output components 214 are also included in the mobile device 210. For example, the input components include a touchscreen, keys or buttons, accelerometers, cameras, and a microphone. The output components 214 include, for example, a speaker and a display. Each of the input components 216 and output components 214 are coupled to a processor 220, which is capable of executing certain functions of the mobile device 210 such as, receiving data from the input components 216, sending data to the output components 214, and storing and retrieving data from the memory elements 222 on the mobile device 210.

The touchscreen or other input component 216 provides one or more inputs to the processor 220 such as notifying the processor 220 of contact events when the touchscreen is touched. The touchscreen includes, or communicates with a hardware controller, such as a touchscreen driver, that interprets raw signals received from the touchscreen and transmits information associated with the contact event to the processor 220. The contact event can be generated from, e.g., a finger or stylus, interaction with the touchscreen that indicates a request by a user to press a virtual key on the virtual keyboard displayed on the mobile device 210. The data characterizing the contact event can include information on the current position of a pointing, or input device, a surface area (size and/or shape) of contact points collectively comprising the contact event, a pressure of the contact event, a duration of the contact event, and a location of the contact event (e.g., X-Y coordinates on the display screen of the device or a distance from a predetermined location on the display of the device). Accordingly, a single contact event can comprise numerous contiguous contact points on the touchscreen device.

The processor 220 may be a single processor or multiple specialized processors, such as a digital signal processor (DSP), application/graphics processor, or other types of processor, dependent on the additional components within the mobile device 210. The processor 220 is coupled to one or more memory elements 222 which include a combination of temporary and/or permanent storage, and both read-only and writable memory, such as static and non-static random access memory (S/RAM), read-only memory (ROM), writable non-volatile memory such as FLASH memory, hard drives, SIM-based components, and other computer readable storage mediums. The processor 220 retrieves and stores data in memory element(s) 222 of the mobile device 210, and executes applications 226 that are stored in the memory elements.

The memory elements 222 store various program components or modules, such as an operating system 224, and various applications 226, such as those downloaded from an application store or database to the mobile device 210. In particular, the memory elements 222 include a contact analyzer module 232, or program, for detecting and analyzing a plurality of (concurrent and/or consecutive) contact events associated with a virtual keyboard displayed on a touchscreen and corresponding program subroutines. The memory elements 222 additionally include a keyboard adaptation module 238 capable of modifying the visual appearance or behavior of the virtual keyboard displayed on the touchscreen based on the static contact events detected by the contact analyzer module 232. The keyboard adaptation module 238 can be a standalone program or a subroutine of the contact analyzer module 232 or other module stored in the mobile device. Additionally, the memory elements 222 may include a virtual keyboard module 230 for generating a virtual keyboard on the touchscreen of the mobile device 210, a multi-touch input module 228 for collecting the contact event data for the virtual keyboard, and a word prediction module 234 for predicting a word based on the detection of an intentional key press. A language model database 236 is also included to provide a selection of predictive words to the word prediction module 234.

Accordingly, as discussed herein, the mobile device 210 includes or stores a contact analyzer module 232 that analyzes contact events to determine whether a contact event represents an intentional key press, an unintentional contact event (mistype or accidental touch), or static contact event. If a contact event is likely to be an intentional key press, the contact analyzer module 232 provides this information to a word prediction module 234 or other analysis tool for conventional handling of user text input. If the contact event is brief and likely to be unintentional, the contact event data may be discarded or otherwise removed from consideration as a contact event. If the contact event is likely to be a static contact event, the contact analyzer module 232 notifies the keyboard adaptation module 238 of that static contact event for further analysis and adaptation of the displayed keyboard.

Any number of attributes characterizing a contact event may be collected on the mobile device 210 for analysis by the contact analyzer module 232. In some embodiments, these attributes or characteristics of the contact event may be detected or determined by the multi-touch input module 228 of the mobile device 210 and stored in a temporary memory of the mobile device 210.

As previously mentioned, in most embodiments, the contact analyzer module 232 is stored in a memory element 212 of the mobile device 210 and is associated with the virtual keyboard module 230 such that each time the virtual keyboard module 230 is called (e.g., by an application or a user), the contact analyzer module 232 is also called. Accordingly, whenever the virtual keyboard is displayed on the device, the contact analyzer module 232 is executed to detect static contact events made by the user, facilitate prediction of an intentional (or desired) key press by the user, and adapt the keyboard to the user. The contact analyzer module 232 can also be integrated with the virtual keyboard module 230 and/or the word prediction module 234.

The virtual keyboard module 230 causes the device to generate and display a virtual keyboard on a touchscreen input component 216. The keyboard may be a virtual keyboard emulating a physical keyboard, such as a keyboard that is implemented on a touch-sensitive surface, presented on a touch-sensitive display, imprinted on a touch-sensitive surface, and so on. Further details regarding suitable text input applications may be found in commonly-assigned U.S. Pat. No. 7,542,029, issued on Jun. 2, 2009, entitled, “SYSTEM AND METHOD FOR A USER INTERFACE FOR TEXT EDITING AND MENU SELECTION,” which is incorporated by reference in its entirety.

The virtual keyboard module 230 can also include an event detection component (not shown) to detect when a user interaction has occurred on the mobile device that warrants the use of the virtual keyboard. For example, if the user selects a text entry field in an electronic mail (email) application or selects a form field on a website page, the event detection component detects an event that requires a keyboard for text entry. The events detected by the event detection component then trigger the virtual keyboard module 230 to present a virtual keyboard on a touchscreen display of the mobile device 210. Alternatively, the event detection component is a stand-alone application or integrated with another application in which text entry is necessitated.

In some embodiments, the virtual keyboard module 230 is also responsible for removing the virtual keyboard from the display once the user has finished a text input session, i.e., finished a particular text entry, as well as changing the size, language, and position of the keyboard dependent on the user's preferences and physical position of the mobile device 210. In other embodiments, the virtual keyboard is removed when one or more contact events exceed a predetermined threshold time (or, other threshold) applied by the contact analyzer module 232 or when the mobile device 210 goes into sleep mode. Additionally, in some embodiments, the keyboard is removed upon detection of another input such as “send” in a text or email.

Referring still to FIG. 2, the multi-touch input module 228 detects contact events between the user and the touchscreen. Specifically, the multi-touch input module 228 is configured to receive input via user interaction with the displayed virtual keyboard and to determine characteristics of the detected contact events. The multi-touch input module 228 collects data related to each of the contact events detected on or proximate to the virtual keyboard, such as the location (e.g., X-Y coordinates of the contact event), duration (e.g., time of continuous user interaction), and size of the contact area (e.g., the surface area of the touch associated with the contact event). The multi-touch input module 228 is further configured to detect any concurrent contact events, including any time overlap of one or more contact events.

The determined characteristics of the contact events are provided to the contact analyzer module 232 which, in turn, uses the characteristics to determine a type of contact event received by the user. Accordingly, the contact analyzer module 232 analyzes characteristics of each contact event detected by the multi-touch input module 228. For example, the contact analyzer module 232 determines an approximate location of each contact event relative to the displayed virtual keyboard. This location data can be utilized not only to aid in determining the type of contact event (e.g., static, unintentional), but also which actual key is an intentional key press and whether the virtual keyboard should be adapted according to a static key press. The location of a contact event can be determined in relation to various predetermined points of reference on the touchscreen or on the displayed keyboard. For example, a reference point (or points) can include a central feature of the displayed virtual keyboard, one or more edges of the virtual keyboard, or one or more points or edges of the touchscreen on the mobile device. In the latter embodiment, the reference point remains fixed, regardless of the keyboard layout prescribed by the application in which the keyboard is called. In embodiments in which the reference point (or points) is relative to a location on the virtual keyboard, that reference point (or points) changes in accordance with any prior adaptation of the virtual keyboard due to a static contact event. This change can facilitate further adaptation of the virtual keyboard, for example, due to small shifts in the static contact event during text entry.

The contact analyzer module 232 additionally determines whether the duration of the contact event meets or exceeds a threshold time for user interaction with the touchscreen of the device. Contact events below a lower threshold time are more likely to be unintentional contact events, whereas contact events exceeding the lower threshold time are more likely to be intentional key presses or static contact events. Similarly, contact events above a higher threshold time are likely to be static contact events.

The contact analyzer module 232 can be utilized to determine numerous other characteristics of each (or a collection of) contact event. For example, the surface area covered by a contact event can be combined with the location and the duration of the contact event to further determine that it is a static or other type of contact event. If a large surface area is covered, combined with other determined characteristics, the system may determine that the contact event is indeed a static event consistent with resting on the touchscreen. Additionally, the contact analyzer module 232 can further assess whether a contact event is a static contact event based on whether the contact event is detected concurrently with another contact event. If it is not detected concurrently with another contact event, then the contact analyzer module 232 may cause the device to go into sleep mode, lock, exit the virtual keyboard module, etc. If it is detected concurrently with another contact event, then it may be determined that the user is still actively using the device and the keyboard should be adapted according to the large surface area being covered by the static contact event.

The word prediction module 234 receives the outputs from the contact analyzer module 232 that qualify as an intentional key press. The word prediction module 234 uses the intentional key or keys identified by the contact analyzer module 232 to predict different words that the user may be attempting to enter by referencing the language model database 236. Accordingly, the language model database 236 provides dictionary-type functionality, selecting words with highest correspondence to the entered text. The possible word selections are displayed to the user, who can then select the desired word or merely continue typing to enter the remaining letters in the word.

The keyboard adaptation module 238 receives outputs from the contact analyzer module 232 that qualify as a static contact event or possible static contact event. For purposes of the remaining discussion, a static contact event can include a detected contact event that corresponds to a resting point on the touchscreen, such as where the user is resting a portion (e.g., finger or palm) of his or her hand or grasping the device while utilizing the virtual keyboard. The static contact events therefore can include contact events meeting or exceeding a threshold time of interaction with the touchscreen of the device and meeting or exceeding a threshold distance (i.e., location) corresponding to a perimeter defined around the virtual keyboard or other element of the virtual keyboard.

The location of a static contact event further can be used to determine whether the keyboard format, or layout, should be modified or adapted on the display of the device. For example, in some embodiments, if the static contact event is located adjacent to and/or extending onto at least a portion of the virtual keyboard (i.e., inside a defined perimeter), the keyboard adaptation module 238 then assesses whether to change the currently displayed location and/or format of the virtual keyboard in order to adapt to any overlap of the user's resting points (static contact events). The keyboard adaptation module 238 can further utilize the size of the static contact event to determine, for example, if the entire keyboard should be shifted in a particular direction or deformed to avoid interference (overlap) from the static contact event.

The mobile device 210 can also include additional components (not shown) that facilitate operation of the device and its various components, including other input components 216, output components 214, a radio and/or other communication components, a camera, a subscriber identity module (SIM), etc. In general, the mobile device 210 stores or contains any and all components, modules, or data files required or used in performing typing corrections, such as by detection, analysis, keyboard adaptation, and word prediction, for text input applications provided by the mobile device 210.

Methods for implementing the aforementioned modules on a device, such as illustrated in FIG. 2, are now described. Reference to particular components within the mobile device 210 may be indicated by a numerical identifier corresponding to FIG. 2.

### IV. Detection of Static Contact Events

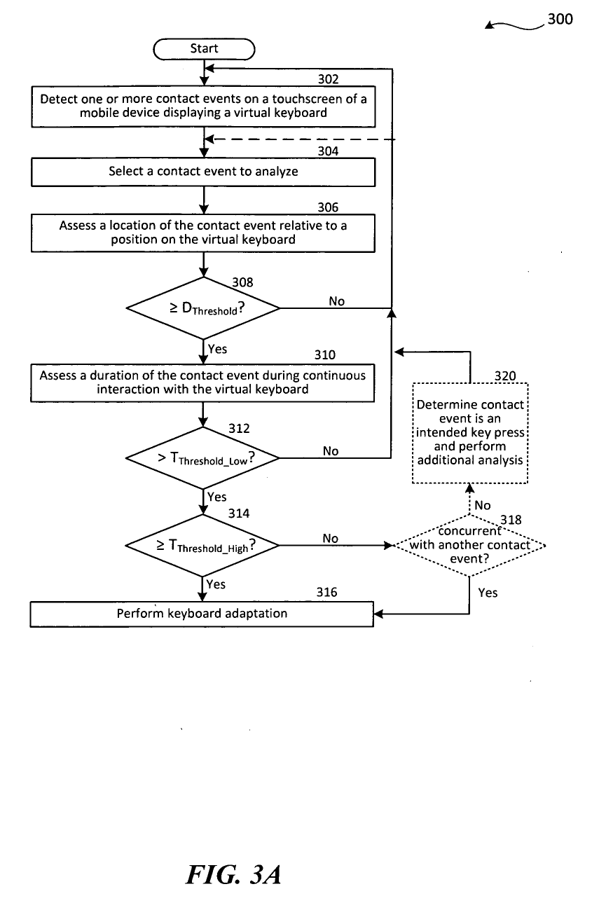

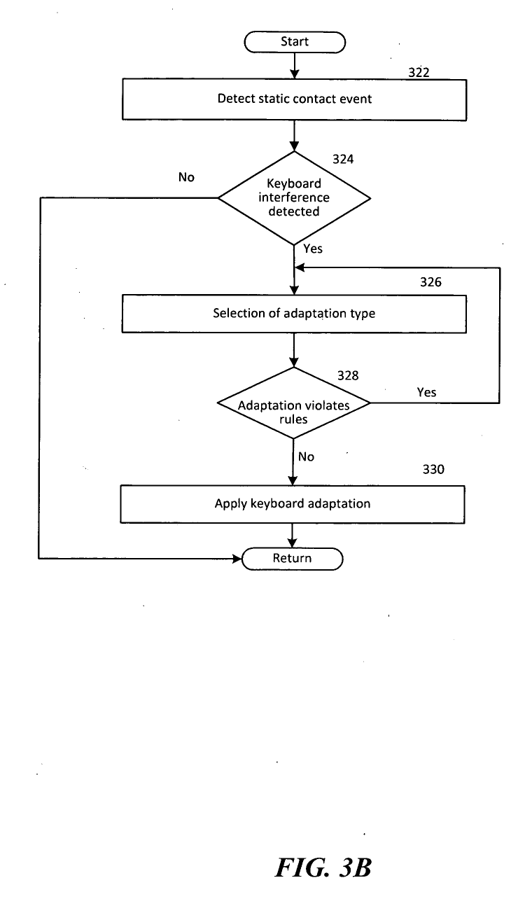

FIG. 3A depicts a method for detecting contact events on a virtual keyboard of an electronic device and assessing whether the contact events are likely caused by an unintentional touch, and if so, whether the unintentional touch is characterized as brief or long. Because the user is not able to physically feel the individuals “keys” of a virtual keyboard, the user is more prone to typing mistakes. Additionally, since the touchscreen may consume substantially the entire face of the device, users often rest portions of their hands directly on the touchscreen while typing. Accordingly, the device can include a software application implementing the aforementioned method to analyze detected contact events and determine which events likely reflect an intentional key press, an unintentional contact event, or a resting point (static contact event) on the touchscreen. In some embodiments, intentional key presses are further processed by a word prediction module to provide one or more predictive words based on the intentional key. In some embodiments static contact events are further analyzed to determine if the keyboard layout or format should be adapted to the user's hand-entry position. Additionally, in most embodiments, both static and unintentional contact events (i.e., mistypes) are discarded, ignored, or otherwise removed from consideration. Implementing this type of contact analysis not only expedites text entry for the user but it also facilitates back-end processing by simplifying the disambiguation processes used to determine which character key is associated with each detected contact event.

Prior to implementing the method adapting a virtual keyboard in response to detected static contact events, the virtual keyboard is first generated for display on the touchscreen of a computing device, e.g., a mobile telephone or tablet computer. In some embodiments, a keyboard module is provided by the operating system of the device. The keyboard module can be always running, or “on”, in the background processes of the device and then called to the foreground when needed for keyed entries. For example, an application executing on the computing device calls the virtual keyboard to enable a user to enter text to that application. The virtual keyboard can be called automatically or by user command within that application, such as through selection of a text field. The virtual keyboard can also be displayed in a set location on the display of the device. In some embodiments, the location varies depending on the device orientation. In some embodiments, the keyboard also varies in size relative to the size of the display screen on the computing device, or relative to the size of the window in which the keyboard is viewable by a user. Additionally, in some embodiments, the application that calls the keyboard determines the formatting and layout of the virtual keyboard dependent on the display of other application content. Accordingly, in such embodiments, the application integration defines the layout and provides that layout information to the virtual keyboard module operating on the mobile device.

Once displayed, the virtual keyboard module maintains a mapping of the locations of each key on the virtual keyboard and the X-Y coordinates of the touchscreen. In other words, for each X-Y location associated with a contact event on the virtual keyboard (e.g., touch by finger, stylus, or other entry device), the keyboard module is able to map the X-Y coordinate to a unique key. Similarly, for each X-Y location proximate to or associated with the keyboard, the keyboard module is able to detect a contact event at that location and determine the relative positioning of the contact event compared to different elements of the displayed virtual keyboard. In some embodiments, the keyboard module also maintains a mapping of a perimeter defined around the keyboard. For example, the perimeter can be defined around an outer edge of each of the outermost keys displayed on the keyboard (e.g., in FIG. 4C). Whether a contact event is found within or without the keyboard perimeter may influence the determination of whether the contact event is intentional or unintentional. Once the process of generating and displaying the virtual keyboard module is complete, the contact events are then detected, collected, and analyzed to disambiguate between intentional and unintentional input. These next steps in the process are now described corresponding to the steps illustrated in FIG. 3A.

To begin, in step 302, multiple contact events are detected on the touchscreen of the computing device. As previously mentioned, contact events are detected based on known touchscreen techniques, such as using a capacitive, resistive or optical wave touchscreen technology. In some embodiments, the contact events are detected during a sampling time interval, such as ten second (10 s) intervals during the time in which the virtual keyboard is displayed on the touchscreen until completion of the keyed entry session. When multiple contact events are detected on the touchscreen during use of the virtual keyboard, those contact events are processed by the contact analyzer module to determine a type of contact event, e.g., an intentional key press, an unintentional contact event (mistype), or static contact event.

During display of the virtual keyboard, the computing device may process the contact events independently at first, but correlate two or more based on proximity in time and location. Therefore, one or more contact events may collectively be treated as a static contact event. However, if it is determined that the two are not related, secondary analysis involving additional factors (i.e., size, pressure, concurrency, etc.) can then be performed to determine which is more likely to be a static contact event.

In some embodiments, evaluation of contact events consider both the start of contact (“touch down”) and the end of contact (“touch up”). For example, after touch down, any continuous contact made with the touchscreen of the device may be treated as part of a single contact event. Accordingly, any slight shifts or movements in the location of the contact event are accounted for and the contact event is still considered as the same event until a touch up occurs. In some embodiments, however, any movement, change in direction, or pause during user interaction with the touchscreen is detected as a new contact event. Various rules may also be specified and implemented regarding user interactions both inside and outside the area of the virtual keyboard that are to be considered as contact events. For example, in some embodiments, any interaction detected outside a defined area (e.g., perimeter 432 in FIG. 4C) encompassing the virtual keyboard is automatically assumed to be static.

In step 304, a contact event in the detected contact events is selected for analysis by the contact analyzer module. The detected contact event and corresponding data, e.g., the characteristics of that contact event, are then collected and processed by the device. For example, the contact analyzer module can be implemented as an algorithm, which provides computer-readable instructions for a method of analyzing the detected contact events. Any number of the characteristics are provided to assist the contact analyzer module in determining whether a contact event is an intentional key press, an unintentional contact event or a static contact event. For example, characteristics of a contact event can include a location of the contact event and a duration of the contact event.

The location of a contact event is one or more X-Y coordinates encompassed by the contact event, as measured at a centroid of the contact event. Alternatively or additionally, the location of the contact event is measured at any one point in a group of contiguous points (X-Y coordinates) of contact caused by user interaction with the touchscreen. In some embodiments, the location of the contact event is specified as a relative distance measured from a reference position. For example, the location of a contact event associated with a virtual keyboard can be an offset from a certain location of the keyboard (e.g., a center point of the keyboard) or a distance from a side, a corner, or a specified point on the touchscreen of the device. The duration is the length of time (e.g., in seconds or milliseconds) that the user's finger or other input mechanism continuously interacts with the touchscreen of the computing device. In some embodiments, the duration is the length of time of interaction measured at a first point of detected contact with the touchscreen. In other words, if the user shifts or moves during interaction, the timing of the contact event restarts.

In further embodiments, characteristics of the contact event which are collected for analysis additionally include size, shape, pressure, cadence, etc. For example, the pressure of the contact event may be used to determine if the contact event corresponds to an intentional key press (e.g., the pressure exceeds a threshold value) or if it corresponds to a resting hand or finger (e.g., the pressure does not exceed a threshold value). For example, the size is the surface area that is covered by the user's finger or other input mechanism during user interaction with the touchscreen of the device. In some embodiments, the surface area is measured as an aggregate of a surface area touched during a time interval spanned by first contact (e.g., touch down) and last contact (e.g., touch up) with the touchscreen. For example, if a user swipes across the touchscreen, the surface area would cover the touch down point, path of the swipe, and touch up point. In alternative embodiments, to account for minor movements made during a single contact event, the surface area is calculated as the mean area covered during the aforementioned time interval between a touch-down and a touch-up. In other embodiments, the surface area is calculated by the area covered when a first contact is made with the touchscreen, e.g., touch down, and any other surface area covered during subsequent movement of the user's input mechanism is ignored. The shape of a contact event can also be defined as a characterization of the surface area of the contact event. For example, the contact event may be circular in shape for a perpendicular touch of the touchscreen, or may be more ovular or oblong in shape for a touch that is not perpendicular, unintentional, or static. Any of the aforementioned characteristics, such as location, duration, shape, size, and surface area, can be considered during analysis of a contact event. Further discussion on contact event characteristics is also provided in previously-referenced U.S. patent application Ser. No. 14/450,095.

As previously discussed, the proximity of contact events, duration of contact events, or concurrency of contact events, and various other factors, such as pressure, can be used to assess the likelihood a contact event represents a certain type of contact event, such as a static contact event. For purposes of the following discussion, two base characteristics of duration and location are assessed for each of the detected contact events. Note, however, that utilizing fewer or more base characteristics is also contemplated. For example, if a contact event cannot be determined from just these two base characteristics, additional characteristics are used during analysis of that contact event to further assess the likelihood that it is a static contact event.

Accordingly, in step 306 of FIG. 3A, the contact analyzer module assesses a first base factor, or characteristic corresponding to the location of the selected contact event. The location of the selected contact event is measured relative to the position of the virtual keyboard. The location is measured in, for example, X-Y coordinates, centimeter, millimeters, pixels, or similar measurement, and is calculated relative to a predetermined position on the virtual keyboard, proximate to the virtual keyboard, or on the touchscreen of the mobile device. In some embodiments, the predetermined position may be a single location relative to the keys displayed on the virtual keyboard, such as a midpoint (e.g., between the “G” and “H” keys), of the virtual keyboard or a corner or edge of the touchscreen. The contact event location is then calculated from, for example, an approximate central point (or, another point) in the surface area covered by the contact event and the predetermined position. In other embodiments, the predetermined position used to interpret the contact event varies depending on the location of the contact event. For example, the predetermined position may be a boundary of the keyboard, such as the perimeter 432 defined around the keys in FIG. 4C. In such embodiments, for example, a contact event near “P” would then be measured from the upper right corner of that perimeter 432. In further embodiments, the contact analyzer module simply determines that a location for a contact event is either inside or outside the perimeter 432.

In step 308, the determined location of the contact event (in relation to a predetermined position, as discussed above) is then measured against a predetermined threshold distance (D_{Threshold} 422), such as illustrated in FIG. 4A. The predetermined threshold distance can be measured from any point along the perimeter 432 in FIG. 4C. If the distance of the selected contact event is greater than or equal to a predetermined threshold distance (D_{Threshold}≦D_{contact} 426, i.e., outside the perimeter of the virtual keyboard), the contact event is considered to be the result of an unintentional user touch, and processing to step 310 for further evaluation. If the distance of the selected contact event is less than the predetermined threshold distance (D_{contact}≦D_{Threshold} 424, i.e., inside the perimeter of the virtual keyboard), the contact event is determined to be an intentional user touch and processing returns to step 302 to detect new contact events or, alternatively, to step 304 to select another contact event detected in the prior sampling interval for further analysis.

In step 310, the selected contact event is assessed to determine a duration of time for that contact event. Specifically, the selected contact event is evaluated to determine an associated duration of time during which the input mechanism (hand, stylus, etc.) is continuously interacting with the touchscreen. For example, the contact event is evaluated to determine the duration of time that a user's finger is in contact with one or more particular points on the touchscreen of the device. This duration of time can be measured from the first point of contact with the touchscreen, such as a touch down on the touchscreen, until a last point of contact with the touchscreen, such as a touch up. The duration of time for the contact event can be measured in seconds or a fraction thereof. Additionally, the duration of time can be measured in relation to the start or stop times of contact events in the multiple contact events detected concurrently (e.g., at the same time) or substantially the same time, e.g., within ˜500 ms. To interpret the type of each contact event based on the duration, the duration can be measured against various predetermined threshold times. Example threshold times are illustrated in FIG. 4B. As illustrated, these threshold times are utilized to determine whether a detected contact event is considered to be an intentional key press, a long unintentional user touch (static contact event), or a brief unintentional user touch. Contact events falling in a range (T_{Threshold}_{_}_{High}≦T_{contact} 416) at or above the upper threshold (T_{Threshold}_{_}_{High} 414) time period are considered static contact events in most embodiments. Contact events falling within the bounded threshold time range (T_{Threshold}_{_}_{Low}≦T_{contact}<T_{Threshold}_{_}_{High} 408) are considered either intentional key presses or, in some cases, static contact events. Finally, contact events falling in a range (T_{contact}<T_{Threshold}_{_}_{Low} 412) below a lower threshold time period (T_{Threshold}_{_}_{Low} 418) are considered accidental, or unintentional interactions with the touchscreen.

Accordingly, in step 312, the duration of the selected contact event is first compared to the lower threshold time period (T_{Threshold}_{_}_{Low} 418) illustrated in FIG. 4B. The depicted timeline 420 reflects possible contact event durations ranging from T₀ to Tₓ, where T₀ is equal to zero and Tₓ is equal to a duration of time in which the keyboard is displayed. Contact events having a duration T_{contact} that falls between T₀ and the lower threshold time period, T_{Threshold}_{_}_{Low}, i.e., within lower range 412, are not considered as intentional key presses nor as static key presses because the duration of time for those contact events is too short. If the selected contact event is in this lower range 412, being less than the lower threshold time period, T_{Threshold}_{_}_{Low} 418, the contact event is considered an accidental or unintentional contact event. For example, if a user accidentally touched a key for a brief instant while entering another intentional key, or brushes outside the keyboard while typing. These rapid key presses or touches on the screen are considered unintentional because they do not purvey a deliberate action (i.e., an actual key press) by the user.

The lower threshold time period 418 can be relatively small (e.g., ≦1 s) in order for rapid key presses by faster typists not to be mistakenly considered as accidental. In some embodiments, the lower threshold time period 418 corresponding to a minimum duration of an intentional key press (T_{Threshold}_{_{—Low}}≦T_{contact}<T_{Threshold}_{_}_{High} 408), and dynamically changes with a user profile, a detected user typing speed, or the size or shape of the displayed virtual keyboard. For example, as will be discussed in following paragraphs, the keyboard can be adapted to a specific user's input needs, e.g., palms resting at base of keyboard, fingers resting on sides of touchscreen, etc. If the displayed virtual keyboard is adapted to a user, that user's typing speed may also increase. Accordingly, in some embodiments, this increased typing speed is accounted for by slightly lowering the predetermined low threshold time period, T_{Threshold}_{_}_{Low}, to conform to that user and ensure that no intentional key presses are mistaken as unintentional or static contact events.

Once a contact event is determined to be unintentional, or a mistype, the contact event is discarded and the method returns to step 302 to detect additional contact events, or to step 304 to assess previously detected contact events. For those contact events lasting at least a lower threshold duration of time, they are further compared to a second threshold duration of time, T_{Threshold}_{_{—High}} 414, discussed further in the following steps.

In step 314, for contact events having a duration of time at or above the lower threshold time (e.g., T_{Threshold}_{_}_{Low}≦T_{contact}), those contact events are then compared to a high threshold time, T_{Threshold}_{_}_{High}. Contact events at or surpassing the high threshold time 414 are considered static contact events, and processing continues to step 316 for keyboard adaption in response to the static contact event, which is described in FIG. 3B. For example, if a user rests his or her hands on a portion of the keyboard, including one or more keys instead of hovering above a virtual keyboard, the duration of the detected contact events on those keys is substantially longer than for an intentional key press or unintentional contact event. Once a contact event is determined to be static, then that contact event can be ignored for purposes of keyed input detection and analysis. Accordingly, though the contact event is detected, the keyboard operates normally as if the contact event were not detected and only the other contact events made during the same keyboard session are further detected and analyzed.

If the evaluation at step 314 shows that the contact event does not have a duration of times above the high threshold time, then the duration T_{contact} of the detected contact event falls within a median threshold time interval 408, and processing continues to step 318 and possibly step 320 for further processing of the detected contact event based on additional characteristics to determine if it is an intentional key press or a static contact event. The further processing is performed due to the uncertainty in this time interval caused by static contact events having shorter durations of time. Specifically, static contact events falling within this time range are more difficult to differentiate because, for example, a text entry session may be quite brief, making the static contact events (e.g., grasping the device) last a shorter amount of time. Also, for example, static contact events during initial use of the displayed keyboard may be detected simultaneously with intentional key presses or change once a user begins typing. For example, if the detected contact event is within the time interval between T_{Threshold}_{_}_{Low}≦T_{Contact}≦T_{Threshold}_{_}_{High}, that contact event can be analyzed additionally based on a size (i.e., surface area) of the contact on the touchscreen, or, based on concurrency with one or more other contact events in the sampling time interval.

Step 318 reduces the possibility that the contact event is an intentional key press. Specifically, step 318 aids in disambiguating initial static contact events (i.e., with shorter durations) from intentional key presses in the event that the two types of contact events cannot be differentiated from the two factors of distance and location alone. In this embodiment, the method 300 further includes determining whether the selected contact event was detected concurrently with another contact event during the sampling time interval. For example, a timestamp for touch down of the selected contact event can be compared to timestamps of other detected contact events in that sample. If one or more contact events are concurrent with the selected contact event being analyzed, the selected contact event can be considered static, and processing continues to step 316 for adapting the keyboard in response to the static contact event, which is described in greater detail in FIG. 3B. In some embodiments, if one or more contact events are concurrent with the selected contact event, then the location of each concurrent contact event is further compared with the selected contact event in order to confirm if the contact event is static. The distance from the perimeter, for example, may be correlated with the likelihood that a contact event is an intentional key press since contact events detected on input keys (i.e., inside the perimeter) are more likely to be intentional key presses than contact events off (i.e., outside the perimeter) the input keys. Accordingly, if concurrent contact events are detected inside or more proximate to the perimeter of the virtual keyboard, then the selected contact event is determined to be a static contact event and processing continues to step 316 for adapting the keyboard to the static contact event, which is described in greater detail in FIG. 3B. If the concurrent contact events are detected on or outside the perimeter, additional analysis can be performed to determine if those concurrent contact events are also static or intentional key presses and to determine if the select contact event should also be considered static.

If at step 318 it is determined that there is no concurrent contact event, then processing continues to step 320 for further analysis of the contact event using additional characteristics. If at step 320 it is determined that the contact event is an intentional key press, the contact event can be further processed, such as through subsequent input into a word prediction application, or algorithm, to enable one or more predictive words to be selectively displayed to the user. The partial words, word pairs, or long words can be compared with a language model, such as an n-gram model with associated probabilities (e.g., language model database 236 in FIG. 2), that is stored in a memory element of the computing device. The language model is used to process a received character string based on common use training data associated with the user of the device and/or the general population. The language model can be a shortened version and the predicted words within that model can include words commonly used both by the general population as well as specific to the user of the computing device.

The two previously discussed factors, and possibly other factors, can also be used to calculate a probability that a detected contact event is a static contact event. In some embodiments, each factor is assessed to calculate a separate probability that the detected contact event represents a static contact event. A sum of the probabilities can then be used to determine an overall confidence level that a particular contact event is a static contact event. If a static contact event is not clearly discernible, such as by having a confidence level that is no greater than other simultaneously-detected contact events, the system can further analyze the detected contact events based on additional factors. For example, in FIGS. 4A and 4B, contact events within ranges 426 and 416, respectively, have a higher probability of being static contact events than a contact event within ranges 426 and 408, though both may be found to be static contact events upon further analysis.

The aforementioned additional processing can continue until the contact event is determined to have a probability or confidence that is a threshold amount above other detected contact events. For example, in a group of three contact events, the confidence level of a particular contact event may be only 50%, but the other two may have confidence levels of 30% and 20%. Under such circumstances, the confidence level of 50% is sufficient to conclude that it is a static contact event. The threshold value may be, for example, a certain percentage (e.g., 20%) higher than other contact events detected at the same time. This calculation may differ, however, based on the number of detected contact events being assessed at any given time, as well, as for additional factors both dependent and independent of the other detected contact events.

If the type of contact event cannot be determined by assessing only the aforementioned factors of location and duration, then other factors may also be analyzed in addition to those factors. For example, a threshold value for surface area can be used to assess a size of a contact event and to determine whether the detected contact event should be considered an intentional key press, static key press, or accidental key press. The size can be considered a measure of the surface area covered by contact made with the touchscreen on the computing device. In some embodiments, the size may be measured by a range of X-Y coordinates associated with a contact event and defining an area of that contact event. For example, the size may be measured in pixels, square centimeters, or other units of measure.

In some embodiments, for example, a contact event having a surface area that is less than a low threshold value is likely to indicate an accidental touch on or proximate to the virtual keyboard. For example, this type of contact event may also be referred to as a ghost touch, which often occurs on the input keys proximate to intentional key presses. These unintentional touches are often made more quickly than the intentional key, so the smaller size of the contact event along with a shorter duration of the contact event may be used in conjunction to indicate to the contact analyzer module that an accidental touch occurred and additionally aid in removing that particular contact event from consideration.

Accordingly, in some embodiments, any contact event indicated over a predetermined size, i.e., a contact event having a surface area exceeding the higher size threshold value, can automatically be determined as static contact events, such as resting touches. For example, the user may rest his/her palms on the virtual keyboard in order to hover their fingers above the home rows keys in preparation to type or, alternatively, grasp the mobile device to secure it. These contact event sizes likely measure above the higher size threshold and are considered static. In some embodiments, however, even though the size exceeds a predetermined threshold value, the contact analyzer module performs additional analysis to determine if the contact event is indeed static. Once it is determined that a contact event is static, that contact event can be further assessed to determine if the virtual keyboard should be adapted to accommodate those static contact events. In some embodiments, if the size of a detected contact event is over a predetermined size, the keyboard adaptation automatically adapts the keyboard and processes the detected contact event as static.

The prescribed surface area threshold range between the low threshold value and the high threshold value thereby defines the range in which a contact event may be considered to be an intentional key press. The prescribed surface area range can vary in order to take into consideration differing sizes of hands, sizes of virtual keyboards, type of device typing styles, prior adaptations to the keyboard, etc.

If the size of the detected contact event falls within the prescribed threshold interval, additional factors may also be analyzed in order to determine if the contact event is an intentional key press or a static contact event. For example, if the user taps on or proximate to keys of the virtual keyboard in the interim between entering text (e.g., while thinking), these taps may inadvertently be considered intentional key presses if additional characteristics are not assessed in association with the detected contact event. Additionally, variations in the pressure of contact events detected on the virtual keyboard may be utilized in determining a type of contact event. For example, intense and inconsistent pressure may be associated with intentional key presses, moderate and consistent pressure may be associated with static contact events, and brief and light pressure may be associated with unintentional contact events.

### V. Keyboard Adaptation in Response to a Static Contact Event

FIG. 3B depicts a method for adapting a virtual keyboard in response to a long unintentional touch, or static contact event, made to a touchscreen of a computing device. By adapting the virtual keyboard, which may involve re-sizing, re-arranging, or shifting all or a portion of the keyboard, the adaptive keyboard system can respond to an interfering static contact event to ensure an uncompromised user experience.

To begin, in step 322, a static contact event is detected. As described above, a static contact event represents an unintentional resting touch to a touchscreen, which may result from a user resting a hand or finger on a touchscreen while typing or from holding the edge of the touchscreen. The detection of a static contact event may follow the steps of method 300, as depicted in FIG. 3A. In addition to the presence of the static contact event, certain characteristics of the event, such as the location of the touch associated with the contact event and the surface area of the touch associated with the contact event, are also detected.

At step 324, the adaptive keyboard system determines if the detected static contact event interferes with the virtual keyboard. If the static contact event is not within a threshold distance of the perimeter or other element of the virtual keyboard, or if the event is not within the perimeter of the keyboard, then the system returns without applying adaptation. If the contact event location is proximate to the perimeter (e.g., on or near the perimeter) or other element, or if the contact event location is within the perimeter of the virtual keyboard, then the contact event likely interferes with the virtual keyboard. To further evaluate the extent of the interference caused by the contact event, one or more of the contact points (i.e., X-Y coordinates on the touchscreen) in the contact event can be assessed to determine if the contact event obstructs or otherwise interferes with one or more of the input keys (i.e., character keys) on the virtual keyboard. In some embodiments, for example, each of the outer contact points in the surface area covered by the static contact event is compared to contact points inside the perimeter of the virtual keyboard to determine if, and how much, overlap exists. Overlap may also be detected if a contact point of the contact event is within a threshold distance of points on the keyboard. If contact points are matched, then the innermost (i.e., most centrally located on the touchscreen) matched contact point is identified as the point of adaptation, and processing continues to step 326.

At step 326, the adaptive keyboard system selects a type of adaptation to correct for the detected static contact event. The adaptation selected should be one that restores unobstructed use of the virtual keyboard in spite of the static contact event. Accordingly, the system uses the location of the point of adaptation and the number of matched contact points (e.g., the size of the overlap), both of which were calculated as part of step 324, to determine the type of adaptation that best accommodates the static contact event. The system also uses the location of the point of adaptation and the number of matched contact points to determine how much shift, skew, re-arranging, re-sizing, or other adaptation of the keyboard should occur. The type of adaptation can also be chosen based on the application integration, e.g., if other visually displayed portions of the application will be affected by the adaptation of the keyboard.

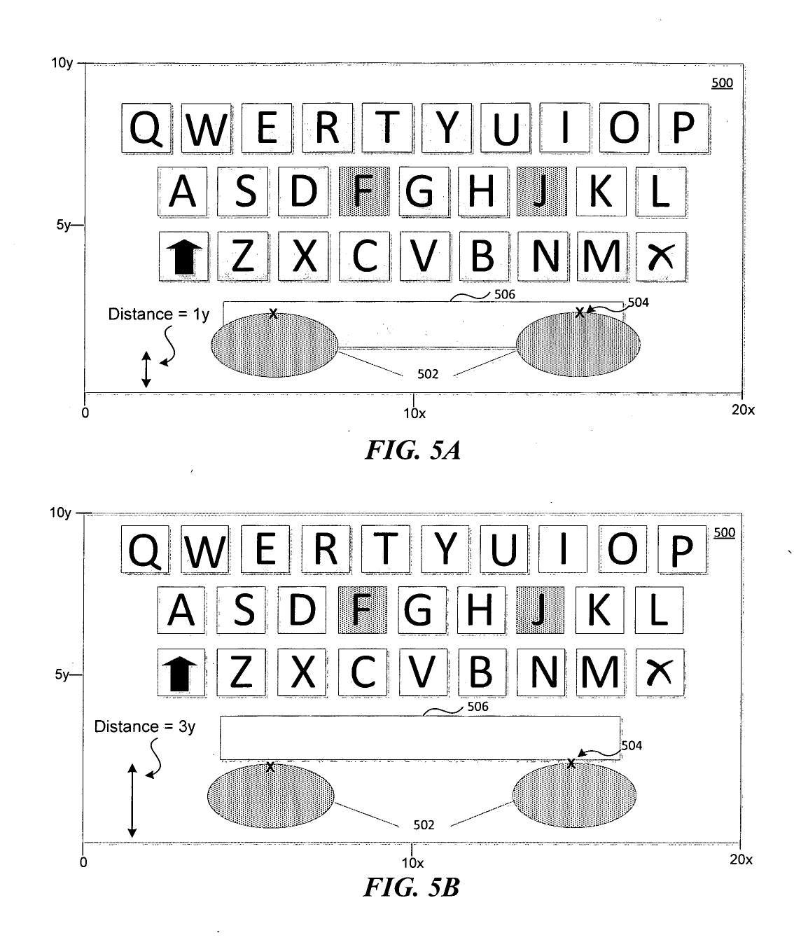

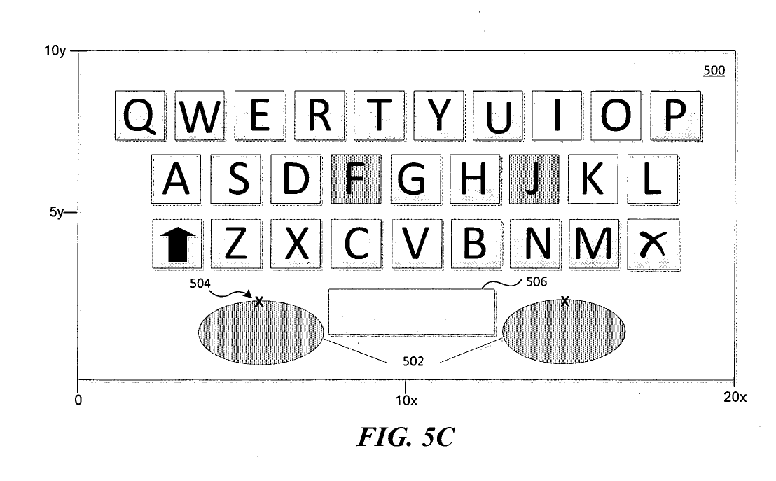

As illustrated in FIGS. 5A-7B and described in greater detail below, one or more of a number of adaptation types may be selected by the system. For example, the entirety of the virtual keyboard may be shifted along the x-axis, y-axis, or both. A keyboard shift might be selected if a static contact event is located along the perimeter of the virtual keyboard. In another example, the size of the virtual keyboard may be uniformly reduced. Such adaptation might be selected, for example, if a large static contact event is located along the perimeter of the virtual keyboard. In a further example, individual keys of the virtual keyboard may be re-arranged, reduced in size, or spaced closer to one another. Such adaptation may be selected, for example, when a static contact event is located within the perimeter of the virtual keyboard.

In addition to selecting a type of adaptation, the system also determines the extent, or required amount, of the adaptation. For example, if a static contact event is located within the perimeter of the virtual keyboard, and if the system selects a shift of the keyboard along the y-axis to avoid the interfering contact event, the system additionally determines the amount of shift needed such that the keyboard's relocated perimeter is a threshold distance away from the static contact event. A similar determination is made for the other adaptation types discussed. The amount of adaptation may be increased to provide additional buffer between the virtual keyboard and the location of the static contact event, for example, in anticipation of a change of location of the static contact event.

Once an adaptation type and amount are selected, processing continues to step 328. At step 328, the adaptive keyboard system evaluates the selected adaptation type and amount to determine whether applying the adaptation to the virtual keyboard would violate any rules. For example, a virtual keyboard shift and shift amount selected by the system could require shifting a portion of the keyboard outside the viewing window of the touchscreen or into touchscreen space allocated to an application running on the device. In another example, it may be determined that a uniform keyboard size reduction selected by the adaptive keyboard system would result in an adapted keyboard that is too small for user use (e.g., key size or spacing between keys would be below some minimum size or distance). If the system determines that applying the selected adaptation would violate a rule, processing returns to step 326 so that a new adaptation type can be selected. Otherwise, processing continues to step 330.

Finally, at step 330, the selected adaptation is applied to the virtual keyboard. Applying the selected adaptation to the virtual keyboard may result in a visual change to the keyboard, such as displaying the keyboard shifted by a selected amount. Alternatively, the applied adaptation may only be logical. When the virtual keyboard is logically adapted, the adaptive keyboard system maps the keys of the virtual keyboard to new touchscreen locations according to the selected adaptation and processes subsequent inputs accordingly. However, the display of the virtual keyboard is not modified (i.e., the keyboard is displayed as it was prior to the detection of the static contact event).

Application of the method of keyboard adaptation illustrated in FIG. 3B is now described with reference to corresponding examples. In FIGS. 5A-7B, embodiments of virtual keyboards, static contact events on virtual keyboards, and adaptations applied in response to those static contact events are illustrated.

### VI. Illustrative Embodiments

As discussed above, the adaptive keyboard system is directed to morphing the display or modifying the behavior of a virtual keyboard in response to a detected static contact event. Static contact events can be caused by various interactions with the touchscreen of the device. For example, a user may hover his or her fingers over a keyboard, tap on the keyboard, or, most commonly, rest his or her hands on the keyboard while typing. As with traditional physical keyboards, users often find a resting point on the keys of virtual keyboards while typing and during time periods between typing portions of a keyed entry. Additionally, users often hold a portion of a touchscreen with one hand while typing with another hand. For example, if a user is typing on a tablet computer, that user may rest his or her palms along the bottom or sides of the touchscreen. In the case of a smartphone, a user may rest his or her thumbs on the screen. Additionally, the keys or a portion of the touchscreen on which a user may rest their hand often depends on the format of the keyboard, the language of the keyboard, the size of the keyboard, the application in which the keyboard is displayed, etc. These various situations are addressed in the following illustrative embodiments.

Referring to FIG. 5A, an exemplary virtual keyboard 500 is illustrated on which one or more static contact events 502 are detected during a sampling time interval of a keyboard session. As previously discussed, the virtual keyboard is displayed on a touchscreen of a computing device, such as a tablet computer or smartphone. The virtual keyboard is typically displayed on a portion of the display screen, leaving the remainder of the display screen for a user to view the text entered on the virtual keyboard 500.

The virtual keyboard 500 can be a QWERTY keyboard or any other keyboard known and commonly used in the art. In some embodiments, the keyboard configuration and formatting may be based on the language in which the user is entering text. In the embodiment shown in FIG. 5A, a home row of keys is located across the middle row of the keyboard, including two home keys “F” and “J”, which users of physical keyboards often use as an on-keyboard resting location for their index fingers. The input keys, also referred to as character keys, on the virtual keyboard can vary in size depending on how many keys are displayed on the keyboard, the language of the keyboard, and the display size of the computing device on which the keyboard is provided. Additionally, the spacing between each of the input keys can vary depending on the size of the screen on which the virtual keyboard is displayed. One or more of the aforementioned formatting variances can also depend on the application integration of the virtual keyboard.

Depending on the display size of the computing device, the previously discussed contact analyzer module (FIG. 2) utilizes differing thresholds for the factors used to assess whether a static contact event is detected. For example, if the display of the computing device is on a smartphone, the surface area of touchscreen is much smaller than a tablet computer and user interactions with the virtual keyboard for each contact event are likely much larger relative to the size of the virtual keyboard than, for example, on a touchscreen monitor of a desktop computer. Furthermore, depending on the orientation of the device, the screen size and, consequently, the size of the keyboard can change. These aforementioned factors along with various others can be utilized in the contact analyzer module software such that each type of device, device orientation, etc., utilizes differing thresholds.

In the embodiment illustrated in FIG. 5A, the detected user interaction (contact events 502) is proximate to the virtual keyboard and traverses the perimeter (e.g., perimeter 432 in FIG. 4C) of the virtual keyboard 500. As previously discussed, satisfying these factors indicates a static contact event. Specifically, as illustrated, the contact events 502 are partially resting on the space bar 506 of the virtual keyboard 500. Assuming that the lower threshold time is surpassed and the higher threshold time is satisfied, it can be determined that the contact event 502 is static. Upon determination of this type of contact event, a point of adaptation 504 is further determined from an innermost contact point of the static contact event. In some embodiments, this point of adaptation 504 can be measured as a distance from an edge of the virtual keyboard. For example, in FIG. 5A, along a horizontal axis (i.e., the x-axis) the keyboard length ranges from “0” to “20x” and along a vertical axis (i.e., the y-axis) the keyboard length ranges from “0” to “10y”. In the illustrated embodiment, the vertical distance to the point of adaptation 504 is approximately equal to “3y”. This distance overlaps with the lower edge of the keyboard perimeter which, as illustrated, is approximately equal to “1y”. So, this 2y overlap indicates that at least a portion of the virtual keyboard should be adapted to accommodate the static contact event, at least up to the point of adaptation 504.

FIG. 5B illustrates one example for adapting the virtual keyboard in the presence of the static contact event 502 in FIG. 5A. In the illustrated embodiment, the entire keyboard is shifted vertically to prevent the static contact event 502 from interfering with the user's text input. The lower perimeter encompassing the input keys (e.g., perimeter 432 in FIG. 4C) is thus moved from a position of “1y” to “3y”. The vertical shift is made, space permitting. Accordingly, if the vertical space is already limited and would cause a portion of the keyboard to surpass the edge of the display area, then the vertical shift may not be an option. For example, if the virtual keyboard has already been shifted to accommodate static contact events and one or more additional static contact events are detected which require another vertical shift, the keyboard adaptation module (FIG. 2) may determine that a secondary adaptation, e.g., a deformation or skew, is necessary due to unavailable vertical space.

The adaptive keyboard system may determine that an alternative to shifting the virtual keyboard is required in response to a static contact event. As described above, an alternative form of adaptation may be required if there is not sufficient touchscreen space to avoid the static contact point interference with a keyboard shift alone. Additional factors, such as the surface area of the interfering static contact event, the number of static contact events, etc., may also require different adaptations.

In the embodiment illustrated in FIG. 5C, the space bar 506 has been re-sized horizontally to avoid interference with the static contact events 502. Accordingly, the contact events 502 no longer overlaps that input key. This deformation helps to prevent unintentional inputs (i.e., spaces), and also helps to prevent additional adaptations to other input keys on the displayed keyboard. In addition to re-sizing the space bar 506, the outer perimeter (e.g., perimeter 432 in FIG. 4C) of the virtual keyboard is redrawn to account for the smaller space bar when facilitating the detection of both future static contact events and adaptation of the virtual keyboard. If the user discontinues interaction with the touchscreen, thereby ending the static contact event but continuing use of the keyboard, the keyboard adaptation module (FIG. 2) can also detect this change and then redraw the perimeter of the virtual keyboard and/or move or reformat the displayed keyboard prior to detecting additional contact events.

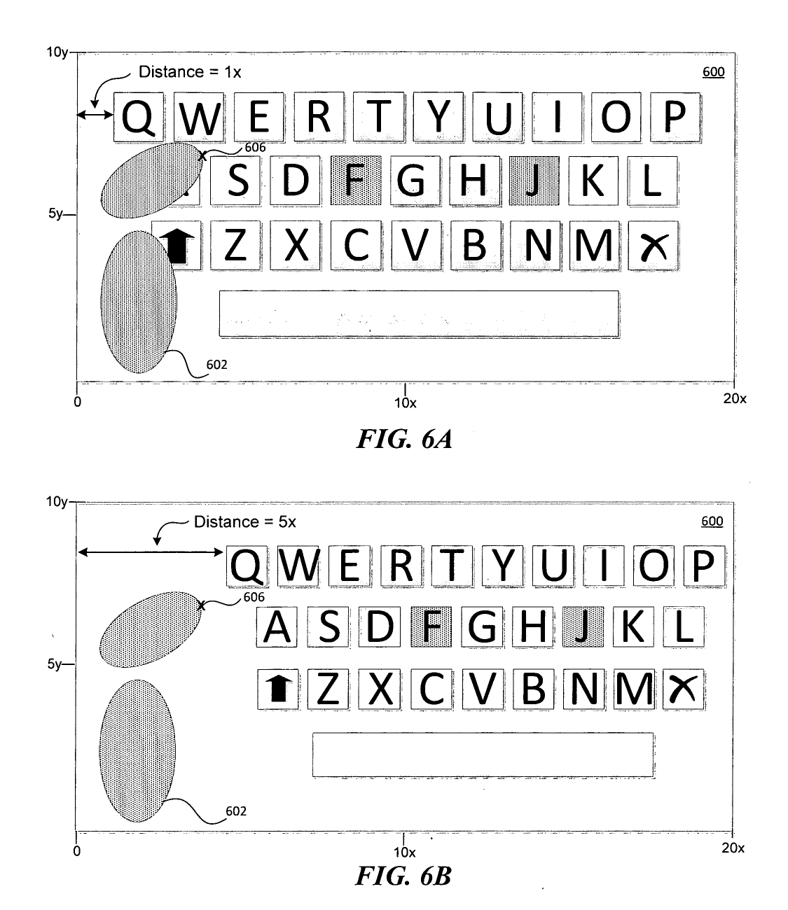

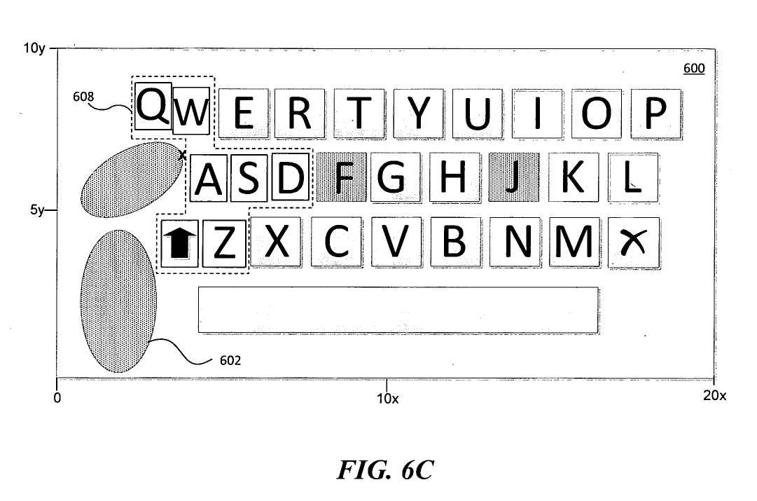

Referring now to FIG. 6A, illustrating another example of illustrating analyzing static contact events 602 on a virtual keyboard. In the illustrated embodiment, the static contact events 602 are detected on the left-hand side of the displayed virtual keyboard 600. Through one or more methods, such as the steps in method 300 discussed with reference to FIG. 3A, it is determined that the contact events are static and also traverse the perimeter defined around the input keys, thereby necessitating adaptation of the virtual keyboard. Embodiments for adapting the virtual keyboard 600 in the presence of these static contact events 602 are described in the following paragraphs with reference to FIGS. 6B and 6C.

In FIG. 6B a first embodiment is shown, in which the virtual keyboard is adapted to the static contact events 602 in FIG. 6A. Specifically, the entire virtual keyboard is shifted horizontally (along the x-axis) toward the right hand side of the touchscreen. The shift can be selected based on the location of the point of adaptation 606 which is further determined by the contact analyzer module during the detection and analysis of the contact events 602. The characteristics for each of the contact events, including the location and contact points covered by the contact events can be collected by the device and the contact analyzer module can determine an innermost point of the contact event as measured from a predetermined central point on the displayed keyboard. This innermost contact point of the static contact event corresponds to the point of adaptation 606. For example, in FIGS. 6A-6C, the point of adaptation 606 is measured at approximately “4x” from the left edge. Using this point of adaptation, the keyboard is shifted by that same amount, 4x, to the right. In the embodiment illustrated in FIG. 6B, the keyboard adaptation module determined that the horizontal shift is the preferred adaptation of the keyboard. As will be discussed in subsequent paragraphs, this is because a vertical shift is not a well-suited approach.

In the aforementioned embodiments, both the horizontal and vertical axes are considered when determining how to adapt the displayed keyboard. For example, in FIG. 6A, the static contact events overlap the input keys approximately to “7y” on the vertical axis and approximately to “4x” on the horizontal axis. Accordingly, in some embodiments, the keyboard adaptation module compares the distance of overlap to determine which shift (horizontal or vertical) would consume less display space, i.e., a shift to “7y” would consume approximately 70% of the space, whereas a shift to “4x” would consume approximately 20% of the space. A horizontal shift is therefore the preferable adaptation.

Referring now to FIG. 6C, an alternate embodiment of adapting the displayed keyboard 600 through deformation is illustrated. Unlike the deformation in FIG. 5C, the deformed character keys 608 have been re-sized and shifted around the area of overlap. For example, the letters “Q” and “W” are shifted vertically and slightly smaller in size. Additionally, the spacing between those character keys is reduced. In some embodiments, only the character keys directly affected by the overlap are deformed. However, in most embodiments, to minimize the re-sizing, re-shaping, and/or movement of the keys on the keyboard, both the overlapped portions and adjacent portions are adapted.

In some embodiments, the keyboard adaptation module first determines if it possible to shift the entire keyboard in just one direction to avoid interference with the static contact event(s), or, if shifting the entire keyboard in both the horizontal and vertical directions helps minimize the amount of shift required to avoid interference, maintain keyboard size, consume less available space, etc. Additionally, as mentioned with reference to FIG. 5A, the contact analyzer module can then determine if a deformation would be more beneficial (e.g., facilitate typing, maximize available space) than shifting the entire keyboard, or in addition to a vertical or horizontal shift.

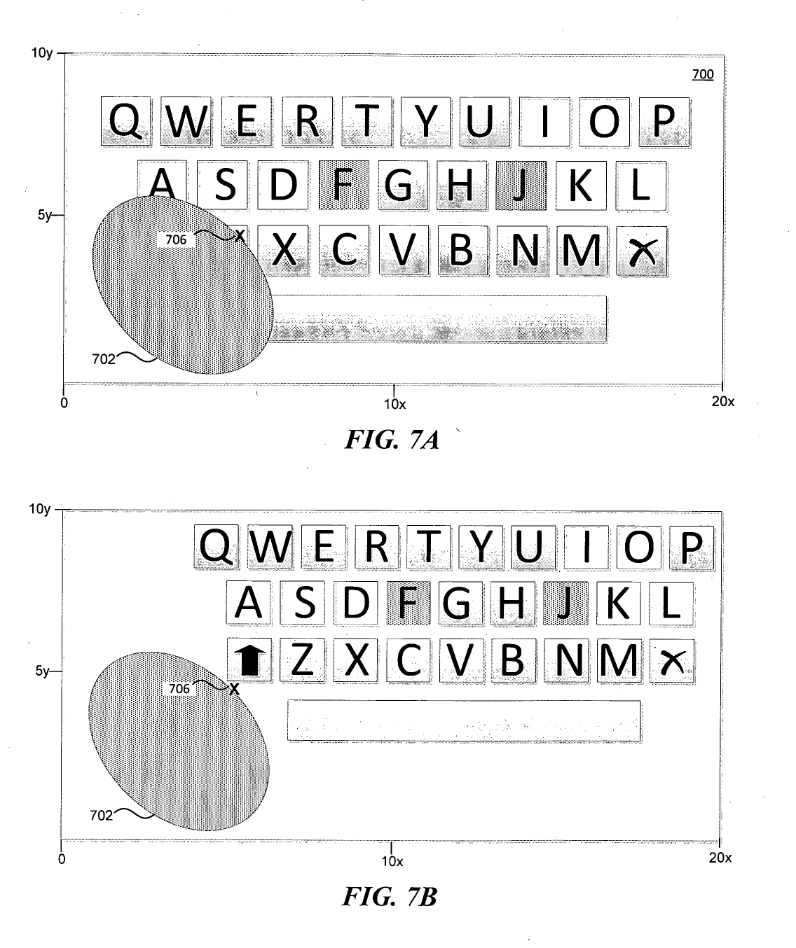

In FIG. 7A, for example, it may be determined that the best possible adaptation is to shift the keyboard across a diagonal. As shown, the contact event 702 covers a large portion in the lower left-hand corner of the virtual keyboard 700, e.g., from a user grasping a tablet with their left hand, while entering text with their right hand. Shifting the keyboard vertically would consume approximately 50% of the display space since the top of the contact event is slightly over “5y”, but requires less shift given the perimeter of the keyboard decreases proximate to the space bar. Such a vertical shift would also require substantial decrease in the size of the keys on the keyboard. Alternatively, shifting the keyboard horizontally would consume approximately 30% of the display space since the right-hand side of the contact event extends horizontally to almost “7x”, but requires less shift given the perimeter of the keyboard decreases proximate to the “A” and shift key. The horizontal shift would also require a substantial decrease in the size of the keys on the keyboard. Accordingly, to avoid interference from the overlapping contact event, the displayed keyboard should be shifted in two directions.

As illustrated in FIG. 7B, the keyboard is adapted along a diagonal from the lower left-hand corner of the virtual keyboard. For example, this diagonal adaptation can be indicated by a function, e.g., y=x−1. So, the keyboard is shifted horizontally to approximately “4x” and vertically to approximately “3y” in order to accommodate the static contact event 702. This shift corresponds to the innermost contact point of the contact event, i.e., the point of adaptation 706, which is located at the intersection of approximately “5x” and “4y”. The keyboard is not shifted as far as the point of adaptation because the decreasing perimeter of the keyboard along the opposite diagonal (i.e., y=−x) eliminates any overlap from the contact event with less shift.

Determining the most preferable direction to shift the keyboard may also be determined by the point of adaptation. For example, as illustrated in FIG. 5A, the point of adaptation 504 is the top-most contact point of the contact event 502. Accordingly, a vertical shift is the preferred direction for adaptation. Similarly, in FIG. 6A, the point of adaptation 606 is the right-most contact point in the contact event 602, so a horizontal shift is the preferable direction. In FIG. 7A, however, the point of adaptation 706 is neither the top, bottom, left, or right, contact point in the contact event 702. Rather, the point of adaptation 706 resides centrally between the top and right of the contact event 702, which indicates that a diagonal shift is the preferable option.

Additionally, to initially determine if a shift or a deformation is the preferred adaptation method, the keyboard adaptation module, alone or in conjunction with another module, may identify whether an entire character key on the keyboard is overlapped (i.e., not visible) by the static contact event or not. If an entire key is overlapped, the keyboard adaptation module can first shift the keyboard based on the point of adaptation and then further adapt, e.g., deform or re-size, the keyboard depending on the available display space for the keyboard. For example, in FIG. 7B, the keyboard is shifted diagonally first since the shift key (i.e., upward arrow) is completely covered by the contact event 702. So, the keyboard is shifted according to the point of adaptation 706 and then uniformly re-sized to fit within the available display space after the shift. Alternatively, to prevent re-sizing the keyboard, the keyboard could be shifted a lesser amount diagonally, and the keys closest to the contact event (e.g., “A”, shift, and space bar) could be deformed, similar to the embodiment illustrated in FIG. 6C.

In summary, the above-described embodiments provide systems and methods to determine whether a contact event should be interpreted as an intentional key press, a static contact event, or unintentional contact event. For example, contact events that are very small in size, short in duration and light in pressure are likely to be accidental, such as ghost touches detected while typing. Contact events that are larger in size, longer in duration and located outside the perimeter of the input keys, are likely to be static touches, such as resting points for a user's hand. Contact events having a short but significant duration, intense pressure, and on or proximate to an input key are likely to be intentional key presses.

Furthermore, though only two examples of static contact events are discussed with reference to FIGS. 5A-5C, 6A-6C and 7A-7B, multiple detected contact events may be assessed by the contact analyzer module at any one time. Similarly, those detected contact events may be utilized for further calculations to determine probabilities and associated confidence levels for a type of contact for each contact event and may be further analyzed based on the attributes of one another, as discussed above with only two contact events.

The techniques disclosed herein associated with a touchscreen may be equally applicable to other touch input technologies such as a touch pad or graphics tablet. Moreover, additional embodiments may be utilized as factors for detecting and interpreting each contact event prior to classifying each event as an intentional key press, unintentional key press, or static key press.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A method for adapting a keyboard displayed on a computing device, the method comprising:
detecting a contact event on a touchscreen of a computing device, the contact event resulting from a user interaction with the touchscreen;
determining whether the contact event is a static contact event based on a duration of contact associated with the contact event and a location of the contact event relative to a location of a first element of a keyboard displayed on the touchscreen, wherein the static contact event represents an unintentional resting interaction from the user; and
modifying the displayed keyboard when it is determined that the contact event is a static contact event, wherein the modification is based on the location of the static contact event relative to a location of a second element of the keyboard and an area of contact associated with the static contact event.

2. The method of claim 1, wherein the determination of whether the contact event is a static contact event is additionally based on a size of the area of contact associated with the contact event.

3. The method of claim 1, wherein the modification of the displayed keyboard comprises spatially shifting a key of the keyboard to avoid an interference from the static contact event.

4. The method of claim 1, wherein the modification of the displayed keyboard comprises decreasing the size of a key of the keyboard.

5. The method of claim 1, wherein the modification of the displayed keyboard comprises spatially shifting the keyboard horizontally, vertically, or both, to avoid an interference from the static contact event.

6. The method of claim 1, wherein the modification of the displayed keyboard comprises uniformly decreasing the size the virtual keyboard vertically, horizontally, or both, to avoid an interference from the static contact event.

7. The method of claim 1, further comprising:
detecting a change in location of the static contact event; and
when it was determined that the contact event is a static contact event, modifying the displayed keyboard based on the changed location of the static contact event.

8. The method of claim 1, further comprising detecting a second contact event on the touchscreen of the computing device, and wherein the determination of whether the contact event is a static contact event is additionally based on the detection of the second contact event.

9. The method of claim 1, wherein the second element of the keyboard on which the modification is based is a perimeter defined around an outer edge of each outermost key on the keyboard.

10. The method of claim 9, further comprising adjusting the defined perimeter based on characteristics of the modified keyboard.

11. The method of claim 1, further comprising, prior to said modifying the displayed keyboard, determining whether the static contact event interferes with a key on the keyboard.

12. The method of claim 11, wherein the displayed keyboard is modified when it is additionally determined that the static contact event interferes with a key on the keyboard.

13. The method of claim 1, further comprising selecting a point of adaptation for the static contact event, wherein the point of adaptation is selected from a plurality of static contact event contact points based on the location of each contact point, and wherein the modification of the displayed keyboard is additionally based on the point of adaptation.

14. The method of claim 1, further comprising reverting the modification of the displayed keyboard when the static contact event is no longer detected on the touchscreen of the device.

15. A tangible computer-readable storage medium containing instructions for performing a method for adapting a keyboard displayed on a computing device, the method comprising:
detecting a contact event on a touchscreen of a computing device, the contact event resulting from a user interaction with the touchscreen;
determining whether the contact event is a static contact event based on a duration of contact associated with the contact event and a location of the contact event relative to a location of a first element of a keyboard displayed on the touchscreen, wherein the static contact event represents an unintentional resting interaction from the user; and
modifying the displayed keyboard when it is determined that the contact event is a static contact event, wherein the modification is based on the location of the static contact event relative to a location of a second element of the keyboard and an area of contact associated with the static contact event.

16. The computer-readable storage medium of claim 15, wherein determining whether the contact event is a static contact event further comprises comparing the duration of contact to a threshold duration and comparing the location of the contact event relative to the first element of the keyboard to a threshold distance.

17. The computer-readable storage medium of claim 16, wherein the threshold duration includes a low threshold duration and a high threshold duration, and wherein the contact event is determined to be a static contact event when the duration of the contact event meets or exceeds the high threshold duration, and wherein the contact event is ignored if the duration of the contact event fails to meet the low threshold duration.

18. The computer-readable storage medium of claim 15, wherein the modification of the displayed keyboard comprises spatially shifting a key of the keyboard to avoid an interference from the static contact event.

19. The computer-readable storage medium of claim 15, wherein the modification of the displayed keyboard comprises decreasing the size of a key of the keyboard.

20. The computer-readable storage medium of claim 15, wherein the modification of the displayed keyboard comprises uniformly decreasing the size of the keyboard vertically, horizontally, or both, to avoid an interference from the static contact event.
